(19) United States
(12) Patent Application Publication
(10) Pub. No.: US 2015/0239284 A1
(43) Pub. Date: Aug. 27, 2015

(54) NOVEL BARNSTAR ASSEMBLY

(71) Applicant: Vernon D. Christian, Mansfield, OH (US)

(72) Inventor: Vernon D. Christian, Mansfield, OH (US)

(21) Appl. No.: 14/187,804

(22) Filed: Feb. 24, 2014

(51) Int. Cl. B44F 3/00

(52) U.S. Cl. CPC B44F 3/00

(57) ABSTRACT

A barnstar includes a plurality of star arms, each of the plurality of star arms formed of first and second facets, each first and second facet presenting an exterior surface, each of the first and second facets being triangular and having a flush periphery edge, an inclined arm length periphery and an inclined assembly edge, with each first and second facet of a star arm being joined at the inclined arm length periphery, each inclined assembly edge providing a interior mounting flange having at least one aperture therein, wherein each interior mounting flange of each of the first facets lies flush against an interior mounting flange of a neighboring one of the second facets such that the apertures therein are aligned and have fasteners therethrough that secure neighboring facets together, with the fasteners being hidden from view at the exterior surface of each first and second facet

### FIELD OF THE INVENTION

The present invention generally relates to barnstars. More particularly, the present invention relates to a barnstar assembly wherein the facets serving to define the star arms and the barnstar appearance are secured in a manner that is hidden from view when the barnstar is mounted to a wall.

### BACKGROUND OF THE INVENTION

Barnstars are popular exterior decorations for not just barns but homes and other buildings. FIG. 1 shows common five-pointed barnstars 1 mounted on the exterior of a home. The structure and assembly of a common five-pointed barnstar 1 is shown in FIGS. 2-6.

The front or exterior side of the barnstar 1 is shown in FIG. 2, while the rear or interior side of the barnstar is shown in FIG. 3. The barnstar 1 includes five arms 10, 20, 30, 40 and 50, with each arm formed from neighboring facets, with arm 10 being formed from facets 10a, 10b; arm 20 being formed from facets 20a, 20b; arm 30 being formed from facets 30a, 30b; arm 40 being formed from facets 40a, 40b; and 50 being formed from facets 50a, 50b. Thus, a barnstar 1 with five arms is formed of ten facets. As can be appreciated from the figures and necessary geometry, each facet is triangular and defined by a flush periphery edge, an inclined arm length periphery and an inclined assembly edge. The facet 10a includes a flush periphery edge 11a, an inclined arm length periphery 12a and an inclined assembly edge 13a. The facet 10b includes a flush periphery edge 11b, an inclined arm length periphery 12b and an inclined assembly edge 13b. The facet 20a includes a flush periphery edge 21a, an inclined arm length periphery 22a and an inclined assembly edge 23a. The facet 20b includes a flush periphery edge 21b, an inclined arm length periphery 22b and an inclined assembly edge 23b. The facet 30a includes a flush periphery edge 31a, an inclined arm length periphery 32a and an inclined assembly edge 33a. The facet 30b includes a flush periphery edge 31b, an inclined arm length periphery 32b and an inclined assembly edge 33c. The facet 40a includes a flush periphery edge 41a, an inclined arm length periphery 42a and an inclined assembly edge 43a. The facet 40b includes a flush periphery edge 41b, an inclined arm length periphery 42b and an inclined assembly edge 43b. The facet 50a includes a flush periphery edge 51a, an inclined arm length periphery 52a and an inclined assembly edge 53a. The facet 50b includes a flush periphery edge 51b, an inclined arm length periphery 52b and an inclined assembly edge 53b.

The flush periphery edges, as the name implies, serve to lie substantially flush against a wall or at least substantially parallel thereto when the barnstar is mounted to a wall. In some embodiments, the flush peripheral edges of each facet all lie in the same plane such that the barnstar can lie flush against a wall. The inclined arm length periphery is described more broadly as a “periphery” in that it need not be an “edge” of a facet. This will be described more fully below. The inclined arm length periphery, as its name implies, generally defines the length of the star arm. It extends from the point of the star arm, where it joins with the flush periphery edge, to the center of the star, where it joins with or lies in close proximity to (depending on the tolerances of the facets themselves) the inclined arm peripheries of the other facets. It can be appreciated that the inclined arm length periphery does not have to be an edge of a facet. That is each facet need not be a separate and distinct element of the barnstar. Instead, each star arm can be defined by two facets joined along the inclined arm length periphery. Thus, each star arm could be formed as a parallelogram folded at an inclined arm length periphery to define the two facets of an arm (see for example FIGS. 5 and 6).

The inclined assembly edge of a given facet closely abuts an inclined arm length edge of a neighboring facet. The inclined assembly edge extends from the flush periphery edge at an end of the flush periphery edge that is opposite the tip of the star, and the inclined assembly edge extends to the center of the star, in close proximity to the terminal ends of the inclined arm length peripheries and inclined assembly edges of other facets. This general structure provides the barnstar with its unique three-dimensional shape.

Thus, facet pairs form arms of the barnstar and abut with neighboring arms at inclined assembly edges. It will be appreciated that the general shape of a barnstar and alterations of the common shapes are known in the art and that the dimensions of each edge and inclination thereof depend upon the desired geometry of a barnstar and can be readily determined from the application of geometry.

In the prior art, a facet-overlap flange extends from one inclined assembly edge of one facet of an arm, while facet apertures are provided proximate the inclined assembly edge in the other facet of that same arm. As seen in FIGS. 5-6, facet 10b of arm 10 includes a facet-overlap flange 14b that includes flange apertures 15b that align with facet apertures 26a proximate inclined assembly edge 23a in facet 20a of arm 20. These two arms 10 and 20 can thus be joined by appropriate fasteners 60. The facet-overlap flange 14b is appropriately angled off of facet 10b to lie substantially parallel to facet 20a. The facet-overlap flange 14b lies underneath the facet 20a to hide from view, but the fasteners are not hidden. It will be appreciated from FIGS. 2-6, that each neighboring pair of facets provide either facet apertures or a facet-overlapping flange with flange apertures serving to align with each other and allow for fasteners to secure the arms together and form the barnstar. The general assembly of FIG. 5 is simply repeated for additional star arms. In a typical five-pointed star, employing two flange apertures per facet-overlap flange, ten fasteners will be visible at the exterior “decorative” side of the barnstar. The fasteners detract from the appearance of the barnstar, and the present invention serves to provide barnstars with an assembly more appropriate to providing an attractive decorative, exterior surface. One arm, such as arm 10, may include a hanger 62 on the interior side of the barnstar to hang the barnstar 1 on a wall W (FIG. 1) with the exterior side visible.

### SUMMARY OF THE INVENTION

A first embodiment of this invention provides a barnstar comprising: a plurality of star arms, each of said plurality of star arms formed of first and second facets, each first and second facet presenting an exterior surface, each of said first and second facets being triangular and having a flush periphery edge, an inclined arm length periphery and an inclined assembly edge, with each first and second facet of a star arm being joined at said inclined arm length periphery, each inclined assembly edge providing a interior mounting flange, wherein each interior mounting flange of each of said first facets lies flush against an interior mounting flange of a neighboring one of said second facets and is secured thereto such that the securing is hidden from view at the exterior surface of each first and second facet.

A second embodiment provides a barnstar as in the first embodiment, wherein each interior mounting flange has at least one aperture therein and each of said first facets lies flush against an interior mounting flange of a neighboring one of said second facets such that the apertures therein are aligned and have fasteners therethrough that secure neighboring facets together, with the fasteners being hidden from view at the exterior surface of each first and second facet.

A third embodiment provides a barnstar as in either of the first or second embodiments, wherein an interior mounting flange of a first facet extends from said first facet at and angle B, while the interior mounting flange of its neighboring second facet extends from said second facet at an angle B, said first and second facet being assembled such that their exterior surfaces form an angle A, wherein angles A+B+C=360.

A fourth embodiment provides a barnstar as in any of the first though third embodiments, wherein angle B equals angle C.

A fifth embodiment provides a barnstar as in any of the first through fourth embodiments, wherein the barnstar has 5 star arms.

A sixth embodiment provides a barnstar as in any of the first through fifth embodiments, wherein each star arm is formed of first and second facets that are formed of a parallelogram bent to form the inclined arm length periphery that joins those first and second facets.

### BRIEF DESCRIPTION OF THE DRAWINGS

FIG. 1 is a perspective view of a house having two barnstars thereon, provided simply to show a general environment of the use of a barnstar;

FIG. 2 is a front elevation view of a five-arm barnstar of the prior art;

FIG. 3 is a rear elevation view of the barnstar of FIG. 2;

FIG. 4 is a perspective view of the front or exterior of the barnstar of FIG. 2;

FIG. 5 is a perspective view showing the joining of two neighboring star arms of the barnstar of FIG. 2;

FIG. 6 is a front elevation view of the neighboring star arms of FIG. 5;

FIG. 7 is a front elevation of a five-arm barnstar in accordance with this invention;

FIG. 8 is a perspective view of a rear or interior of the barnstar of FIG. 7;

FIG. 9 is a perspective view showing how the individual star arms of the barnstar of FIG. 7 neighbor each other for assembly;

FIG. 10 is a perspective view showing the joining of two neighboring star arms of the barnstar of FIG. 7;

FIG. 11 is a perspective view showing the joinder of the star arms of FIG. 10;

FIG. 12 is a cross-sectional view taken along the line 12-12 of FIG. 11; and

FIG. 13 is a cross-sectional view similar to FIG. 12, but showing interior mounting flanges extending at different angles from neighboring facets.

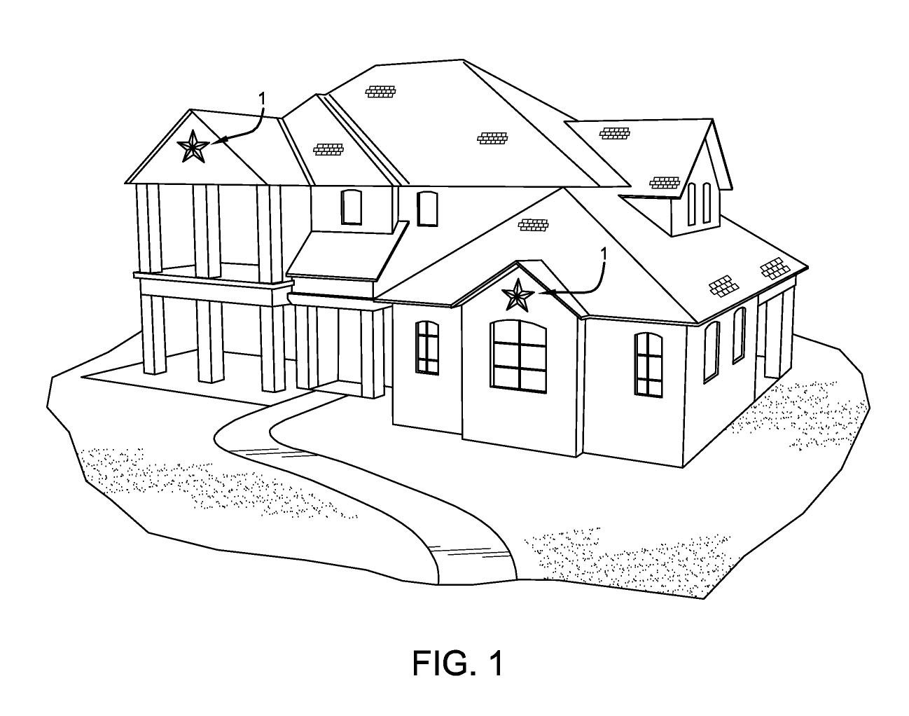

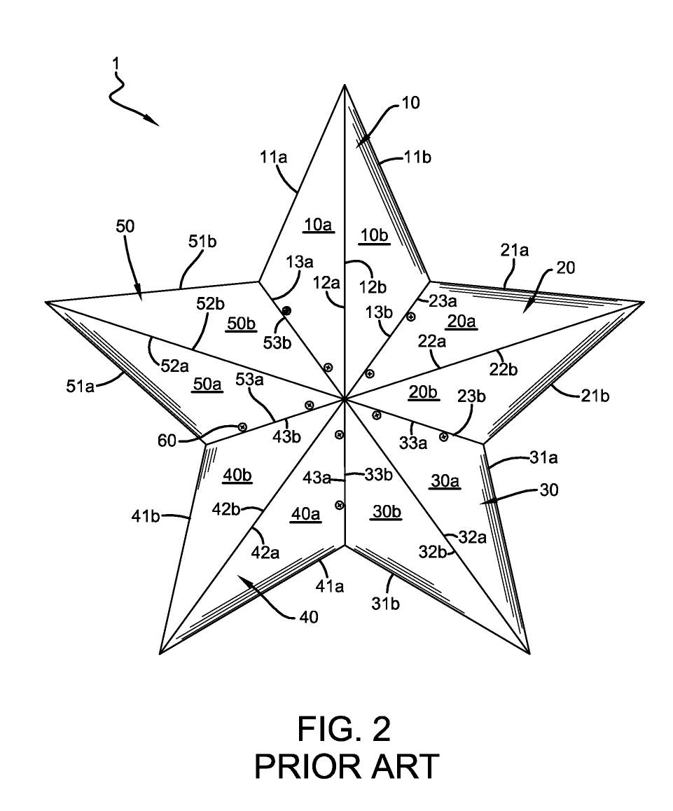

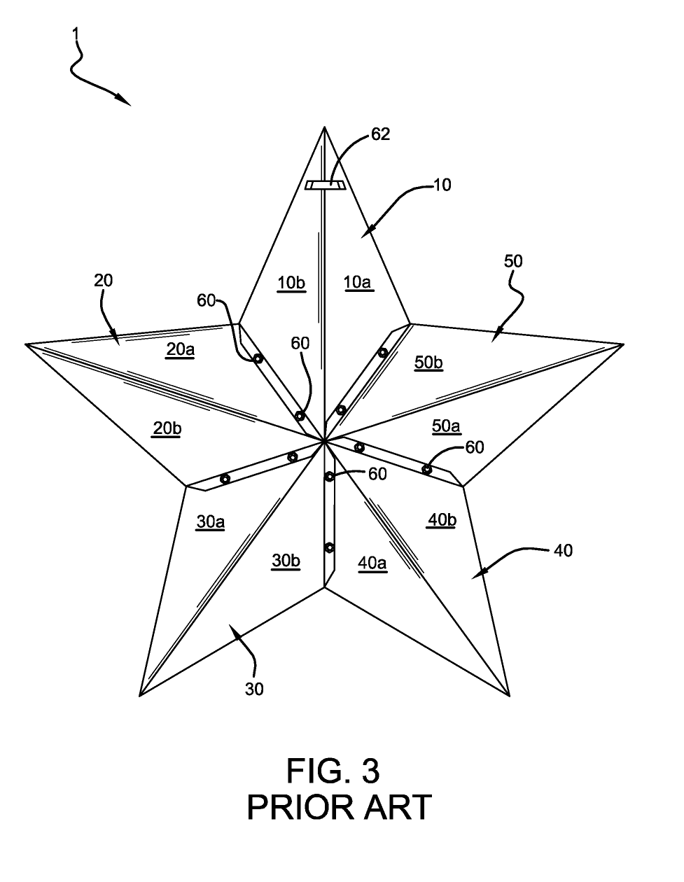

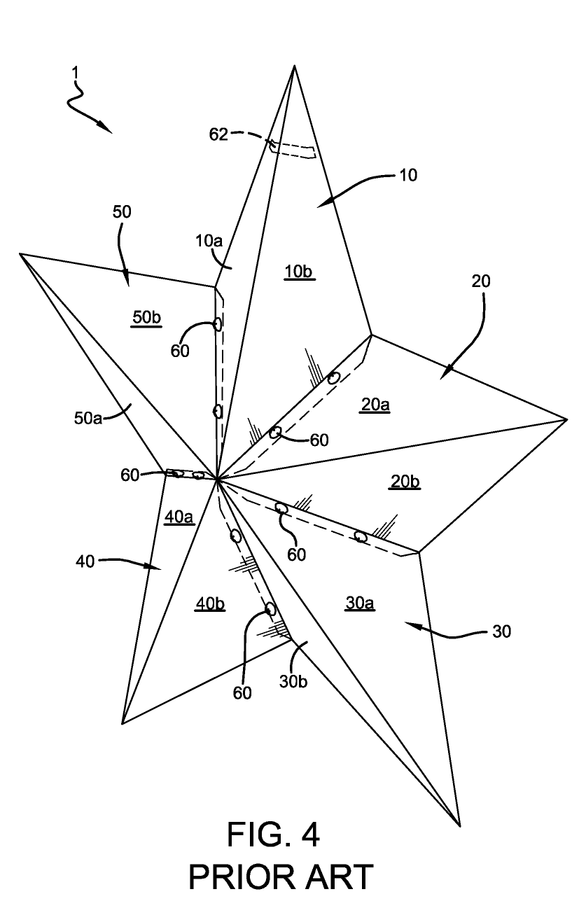

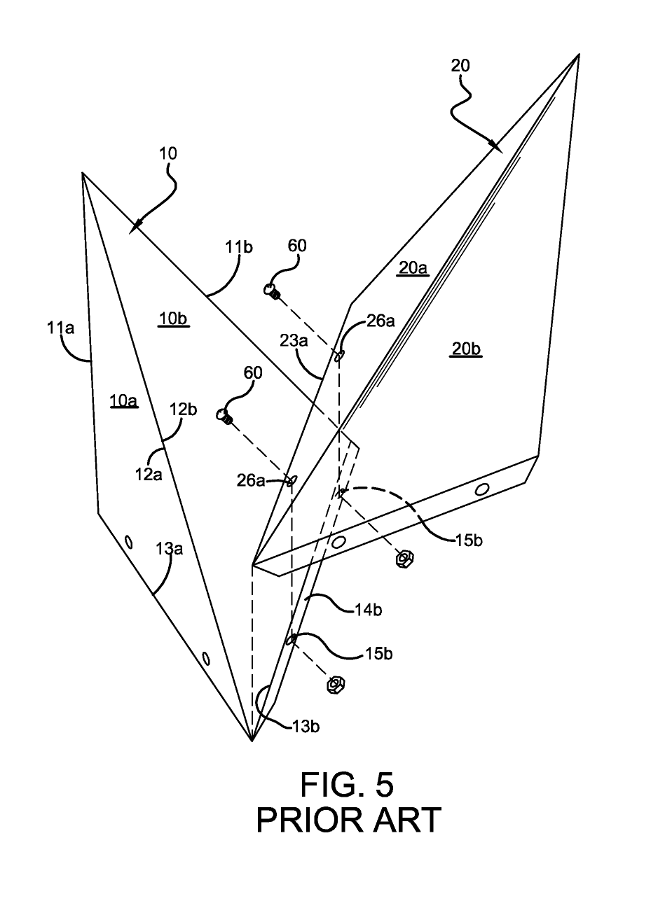

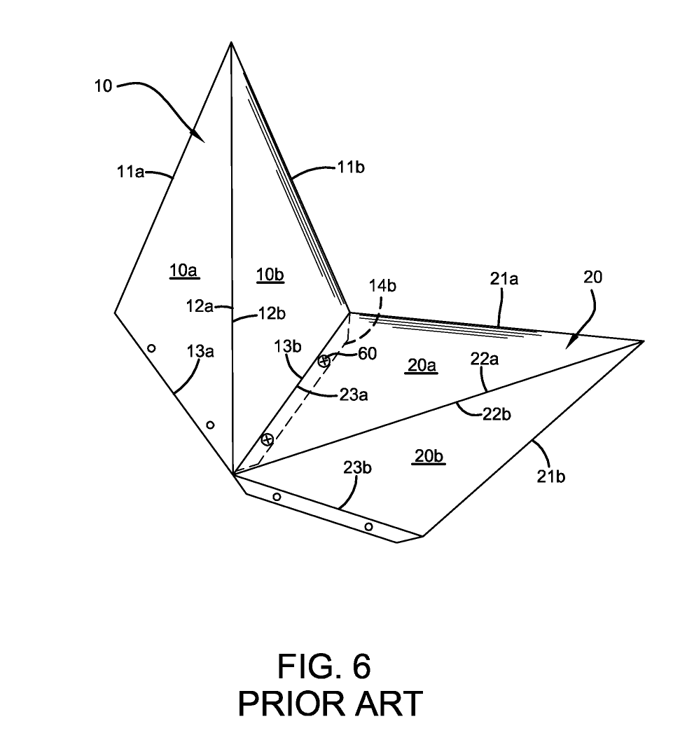

### DETAILED DESCRIPTION OF ILLUSTRATIVE EMBODIMENTS

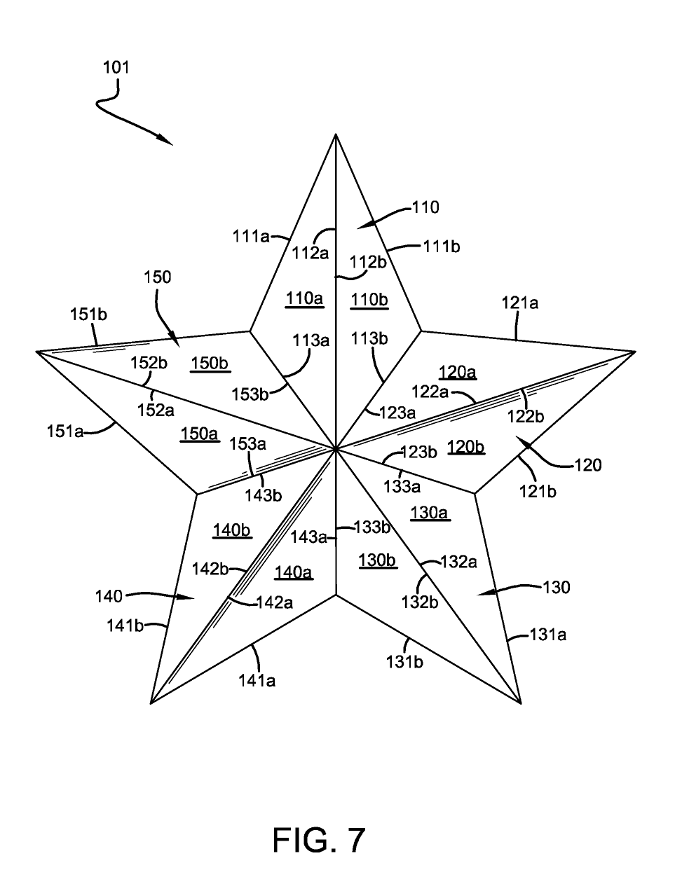

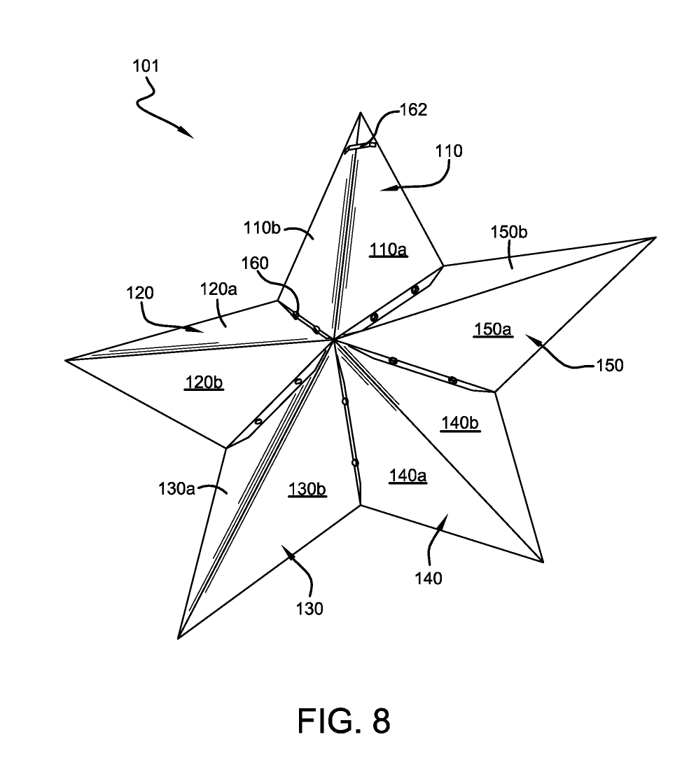

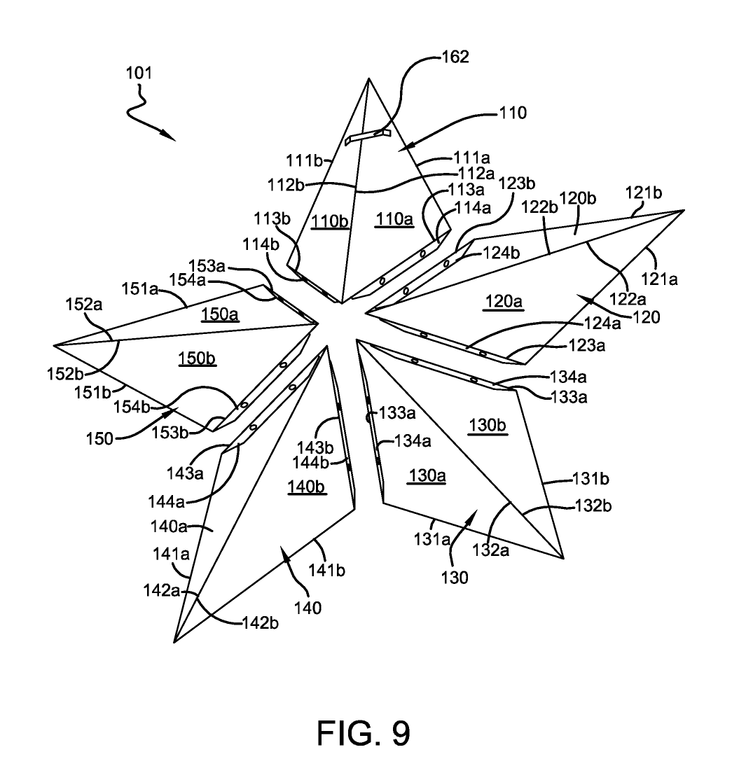

With reference to FIGS. 7-13, the present invention provides a barnstar 101 that is in many respects similar to known barnstars, but includes structures that permit the barnstar to be assembled in a manner wherein the fasteners employed to secure neighboring facets are hidden at the rear or interior side of the barnstar. The barnstar 101 includes five arms 110, 120, 130, 140 and 150, with each arm formed from neighboring facets, with arm 110 being formed from facets 110a, 110b; arm 120 being formed from facets 120a, 120b; arm 130 being formed from facets 130a, 130b; arm 140 being formed from facets 140a, 140b; and 150 being formed from facets 150a, 150b. Thus, a barnstar 101 with five arms is formed of ten facets. As can be appreciated from the figures and necessary geometry, each facet is triangular and defined by a flush periphery edge, an inclined arm length periphery and an inclined assembly edge. The facet 110a includes a flush periphery edge 111a, an inclined arm length periphery 112a and an inclined assembly edge 113a. The facet 110b includes a flush periphery edge 111b, an inclined arm length periphery 112b and an inclined assembly edge 113b. The facet 120a includes a flush periphery edge 121a, an inclined arm length periphery 122a and an inclined assembly edge 123a. The facet 120b includes a flush periphery edge 121b, an inclined arm length periphery 122b and an inclined assembly edge 123b. The facet 130a includes a flush periphery edge 131a, an inclined arm length periphery 132a and an inclined assembly edge 133a. The facet 130b includes a flush periphery edge 131b, an inclined arm length periphery 132b and an inclined assembly edge 133c. The facet 140a includes a flush periphery edge 141a, an inclined arm length periphery 142a and an inclined assembly edge 143a. The facet 140b includes a flush periphery edge 141b, an inclined arm length periphery 142b and an inclined assembly edge 143b. The facet 150a includes a flush periphery edge 151a, an inclined arm length periphery 152a and an inclined assembly edge 153a. The facet 150b includes a flush periphery edge 151b, an inclined arm length periphery 152b and an inclined assembly edge 153b.

The flush periphery edges, as the name implies, serve to lie substantially flush against a wall or at least substantially parallel thereto when the barnstar is mounted to a wall. In some embodiments, the flush peripheral edges of each facet all lie in the same plane such that the barnstar can lie flush against a wall. The inclined arm length periphery is described more broadly as a “periphery” in that it need not be an “edge” of a facet. This will be described more fully below. The inclined arm length periphery, as its name implies, generally defines the length of the star arm. It extends from the point of the star arm, where it joins with the flush periphery edge, to the center of the star, where it joins with or lies in close proximity to (depending on the tolerances of the facets themselves) the inclined arm peripheries of the other facets. It can be appreciated that the inclined arm length periphery does not have to be an edge of a facet. That is each facet need not be a separate and distinct element of the barnstar. Instead, each star arm can be defined by two facets joined along the inclined arm length periphery. Thus, each star arm could be formed as a parallelogram folded at an inclined arm length periphery to define the two facets of an arm.

The inclined assembly edge of a given facet closely abuts an inclined arm length edge of a neighboring facet. The inclined assembly edge extends from the flush periphery edge at an end of the flush periphery edge that is opposite the tip of the star, and the inclined assembly edge extends to the center of the star, in close proximity to the terminal ends of the inclined arm length peripheries and inclined assembly edges of other facets. This general structure provides the barnstar with its unique three-dimensional shape.

Thus, facet pairs form arms of the barnstar and abut with neighboring arms at inclined assembly edges. It will be appreciated that the general shape of a barnstar and alterations of the common shapes are known in the art and that the dimensions of each edge and inclination thereof depend upon the desired geometry of a barnstar and can be readily determined from the application of geometry.

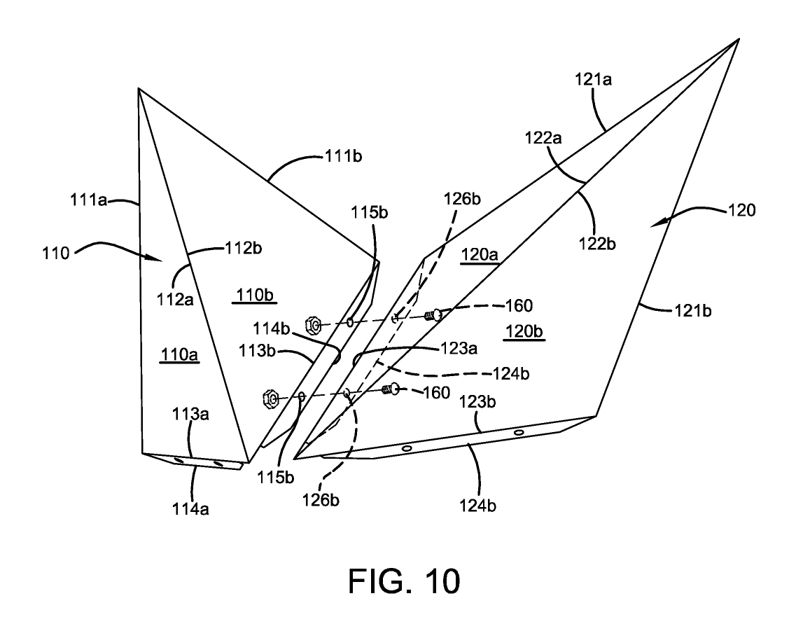

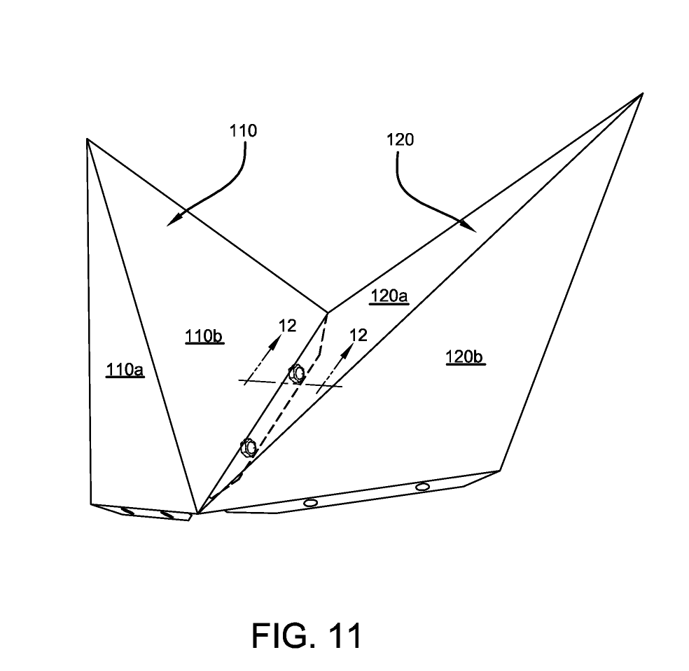

In the present invention, interior mounting flanges extend from each inclined assembly edge of each facet of an arm. Each interior mounting flange has apertures, and each interior mounting flange is angled such that neighboring pairs of interior mounting flanges lie flush against each other when the facets are arranged to form the barnstar. The apertures in the interior mounting flange align so as to receive fasteners. Thus, as seen in FIG. 10, facet 110b of arm 110 includes an interior mounting flange 114b extending from inclined assembly edge 113b and including flange apertures 115b that align with flange apertures 126a in an interior mounting flange 124b extending off of facet 120a of arm 120. These two arms 110 and 120 can thus be joined by appropriate fasteners 160 inserted through the flange apertures 115b, 126a. The interior mounting flange 114b is appropriately angled off of facet 110b, and the interior mounting flange 124b is appropriately angled off of facet 120a so that the two mounting flanges 114b and 124b lie substantially flush with each other, with flange apertures 115b and 126a aligned for receipt of the fasteners 160. It will be appreciated from FIGS. 7-13, that each neighboring pair of facets provide mounting flanges intended to lie flush with each other to align apertures therein and permit fastening of each facet together to form the barnstar. The general assembly of FIG. 11 is simply repeated for additional neighboring facets/star arms. Though two apertures are shown in each interior mounting flange, it will be appreciated that any number could be employed, though two, with one near each end of the interior mounting flange provides for a stable assembly.

In other embodiments, the flush interior mounting flanges need not have apertures for the receipt of fasteners. Instead, the neighboring interior mounting flanges, such as flanges 114b and 124b focused on above, can be joined by crimping. A crimp joining is a known technique in the metalworking arts and is thus particularly useful when the neighboring interior mounting flanges are formed of a metal or other ductile material. The material of one or more of the neighboring interior mounting flanges is deformed to hold the two together.

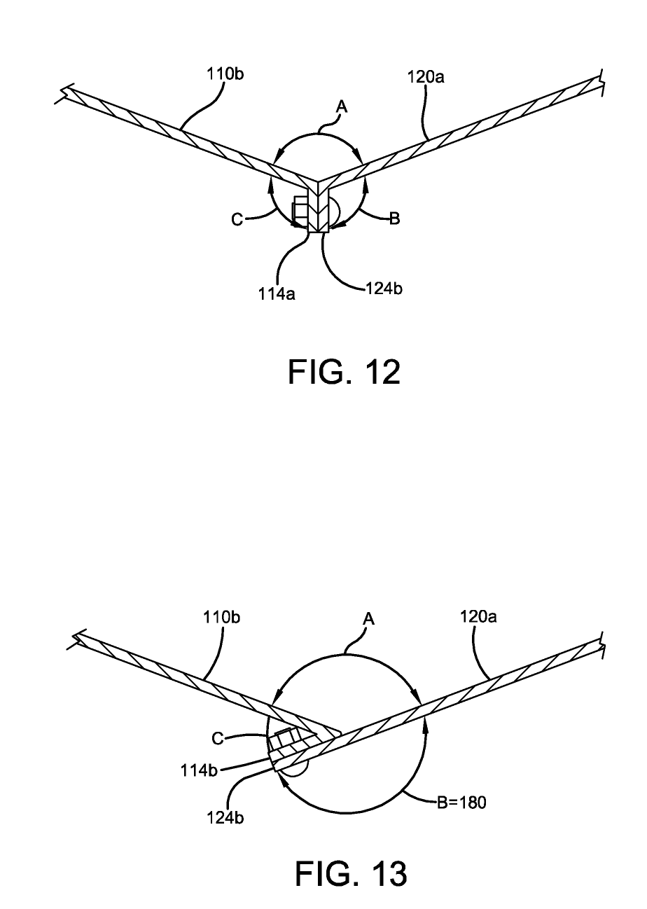

With reference to FIGS. 12 and 13, it will be appreciated that neighboring facets will assemble at an exterior angle A. Thus, it will further be appreciated that one interior mounting flange can extend at an interior angle B, while the neighboring, mating interior mounting flange can extend at an interior angle C, according to the general equation that A+B+C=360°. It should be appreciated that one interior mounting flange of a mating pair could simply be an extension of the facet from which it extends, thus forming a 180° angle, as generally represented in FIG. 13 at angle B between facet 120a and interior mounting flange 124b. In this case, the neighboring interior mounting flange 114b will extend from facet 110b at an interior angle C, wherein the exterior angle A plus interior angle C equal 180°. In other embodiments, the angles B and C will be equal (B and C=(360°-A)/2).

In a specific embodiment, angles B and C are equal and each arm is formed as a parallelogram folded at the inclined arm length periphery to define the two facets of the arm. Each arm is identical, with each interior mounting flange extending at an angle of (360°-A)/2. Thus each arm is its own unit identical to all other arms.

With this structure, the fasteners 160 are hidden behind the facets, at the interior of the barnstar 101. This provides a better appearance than the prior art. The interior mounting flanges lie behind the facets such that they are hidden from view when the barn stare is mounted to a wall. A hanger 162 can be provided to facilitate mounting to a wall.

In light of the foregoing, it should be appreciated that the present invention significantly advances the art by providing a barnstar that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A barnstar comprising:
a plurality of star arms, each of said plurality of star arms formed of first and second facets, each first and second facet presenting an exterior surface, each of said first and second facets being triangular and having a flush periphery edge, an inclined arm length periphery and an inclined assembly edge, with each first and second facet of a star arm being joined at said inclined arm length periphery, each inclined assembly edge providing a interior mounting flange, wherein each interior mounting flange of each of said first facets lies flush against an interior mounting flange of a neighboring one of said second facets and is secured thereto such that the securing is hidden from view at the exterior surface of each first and second facet.

2. The barnstar of claim 1, wherein each interior mounting flange has at least one aperture therein and each of said first facets lies flush against an interior mounting flange of a neighboring one of said second facets such that the apertures therein are aligned and have fasteners therethrough that secure neighboring facets together, with the fasteners being hidden from view at the exterior surface of each first and second facet.

3. The barnstar of claim 1, wherein an interior mounting flange of a first facet extends from said first facet at and angle B, while the interior mounting flange of its neighboring second facet extends from said second facet at an angle B, said first and second facet being assembled such that their exterior surfaces form an angle A, wherein angles A+B+C=360.

4. The barnstar of claim 3, wherein angle B equals angle C.

5. The barnstar of claim 4, having 5 star arms.

6. The barnstar of claim 1, wherein each star arm is formed of first and second facets that are formed of a parallelogram bent to form the inclined arm length periphery that joins those first and second facets.
